(19) United States
(12) Patent Application Publication
(10) Pub. No.: US 2012/0323631 A1
(43) Pub. Date: Dec. 20, 2012

(54) SYSTEMS AND METHODS FOR TRACKING INDUSTRY SPEND

(75) Inventors: Brian C. Bender, New York, NY (US); David S. Bonalle, New Rochelle, NY (US); Patrick R. Lowery, New York, NY (US); Rajendra R. Rane, Edison, NJ (US); Pranay K. Reddy, Brooklyn, NY (US)

(73) Assignee: American Express Travel Related Services Company, Inc., New York, NY (US)

(21) Appl. No.: 13/160,270

(22) Filed: Jun. 14, 2011

(51) Int. Cl. G06Q 30/00; G06Q 40/00

(52) U.S. Cl. 705/7.31; 705/7.33; 705/7.29; 705/36 R

(57) ABSTRACT

Various systems and methods for tracking industry spend are provided herein in various embodiments. A method if provided comprising summing consumer spend with a first company over a time period to yield a raw consumer spend, wherein the consumer spend is derived from internal data, extrapolating an estimated consumer spend with the first company using the raw consumer spend for the first company and the internal data, and estimating, by the processor, top line revenue for the first company using the estimated consumer spend.

### FIELD

The disclosure generally relates to financial analysis, and more particularly, to systems and methods for tracking industry spend.

### BACKGROUND

Publicly traded companies tend to release financial performance results on a regular basis, for example, quarterly and/or annually. Financial performance results tend to affect a publicly traded company's stock price. In addition, securities and/or derivatives that depend on underlying stock prices may change in value depending upon financial performance results. Closely held companies (certain C corporations, S corporations, LLCs, LLPs, LPs, GPs, etc.) may not need to release financial performance results, so potential investors are not able to obtain financial performance results without a specific request. It would thus be advantageous to gain insight into financial performance results of a company prior to the public release of such results.

### SUMMARY

Various systems and methods for tracking industry spend are provided in various embodiments. A method is provided comprising summing consumer spend with a first company over a time period to yield a raw consumer spend, wherein the consumer spend is derived from internal data, extrapolating an estimated consumer spend with the first company using the raw consumer spend for the first company and the internal data, and estimating top line revenue for the first company using the estimated consumer spend.

In various embodiments, the method further comprises summing consumer spend with a plurality of companies within the industry of the first company over the time period and the raw consumer spend to yield a raw industry consumer spend, extrapolating an industry estimated consumer spend using the raw industry consumer spend and the internal data and estimating top line revenue for the industry using the industry estimated consumer spend. In various embodiments, the method further comprises using internal data to filter the industry estimated consumer spend by at least one of geographic location, gender, age, annual income level and education level.

In various embodiments, a system for analyzing industry spend is provided comprising a first data store having internal data, a second data store having data related to a first company within an industry, a non-transitory memory communicating with an industry spend processor, the non-transitory memory having instructions stored thereon that, in response to execution by the processor, cause the processor to perform operations comprising summing, by the processor, consumer spend with the first company over a time period to yield a raw consumer spend, wherein the consumer spend is derived from the internal data, extrapolating, by the processor, an estimated consumer spend with the first company using the raw consumer spend for the first company and the internal data, and estimating, by the processor, top line revenue for the first company using the estimated consumer spend.

In various embodiments, a method is provided comprising summing consumer spend with a first company over a time period to yield a raw consumer spend, wherein the consumer spend is derived from internal data, extrapolating an estimated consumer spend with the first company using the raw consumer spend for the first company and the internal data, and predicting future consumer spend with the first company for a future time period based upon the estimated consumer spend, internal data, and third party data.

### BRIEF DESCRIPTION OF THE DRAWINGS

The above and other features and advantages are hereinafter described in the following detailed description of exemplary embodiments to be read in conjunction with the accompanying drawing figures, wherein like reference numerals are used to identify the same or similar parts in the similar views, and:

FIG. 1 illustrates a system, according to various embodiments;

FIG. 2 illustrates a method of tracking spend of a merchant, according to various embodiments;

FIG. 3 illustrates a method of tracking spend of a merchant by SKU, according to various embodiments; and

FIG. 4 illustrates a method of tracking spend of a industry, according to various embodiments; and

FIG. 5 illustrates a method of predicting future consumer spend, according to various embodiments.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment. Terms similar to “connect” may include a partial or full connection and/or a partial or full interface.

Systems, methods and computer program products are provided. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles. The disclosure may be implemented as a method, system or in a computer readable medium.

As used herein, the term “consumer” may mean any person or entity that consumes or uses an item. As used herein, a customer may mean a person or entity that has purchased and/or may purchase in the future an item from a given business entity, such as a merchant. Thus, a customer list may be a list of people or entities that have purchased or may purchase an item from another entity, such as a merchant. As used herein, a merchant may mean a business entity (i.e., a company) that sells items to the general public. Also as used herein, the concepts discussed with relationship to merchants may be applied to other business entities, thus the terms merchant, business entity, and company are interchangeable with respect to the industry spend tracking methods and systems disclosed herein.

Investors may be interested in estimating or extrapolating a company's sales. Sales, together with other forms of income (such as disposition of appreciated capital assets), typically comprise top line revenue. Top line revenue may be used to determine bottom line revenue (also referred to as net revenue) by subtracting various costs. Estimating or extrapolating a company's sales may thus provide insight into the potential performance of the company's stock price. Such information may also be useful in markets for derivatives that depend on the company's underlying stock.

Many companies, including many merchants, accept payments via transaction systems. Transaction systems are typically associated with a transaction account. Transaction systems may facilitate the payment of a merchant or other company through the transaction account. For example, a transaction system may facilitate a credit card, charge card, or debit card purchase. Transaction systems thus contain extensive sales data relating to a variety of merchants.

In various embodiments, a data store comprises internal data. Phrases similar to “Internal data” may include any data a credit issuer possesses or acquires pertaining to a particular consumer or group of consumers. Internal data may be gathered from a transaction system, such as a closed loop transaction system. Internal data may be gathered before, during, or after a relationship between the credit issuer and the transaction account holder (e.g., the consumer or buyer). Such data may include consumer demographic data. Consumer demographic data may include any data pertaining to a consumer. Consumer demographic data may include consumer name, gender, age, address (including ZIP code and 4 digit extension, also known as “ZIP+4”), telephone number, email address, employer and social security number. Consumer transactional data may include any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

A large amount of internal data (e.g., internal data relating to thousands or millions of consumers) may be used to effectively estimate or extrapolate the sales of a company. For example, analysis of internal data may find a total amount of consumer spend at a given merchant, merchant location (e.g., a single store or online store), or a group of merchant locations (e.g., all merchant stores in a given geography or a given randomly selected cohort). The consumer spend, which may be referred to as raw consumer spend, may be determined by summing the transaction amounts for a given merchant. For example, in various embodiments, using SQL as described herein, one may use the query SELECT sum(transaction_amount) FROM merchant_transactions WHERE [DATE is in a given range], where transaction_amount is the total amount for a transaction (with or without taxes, which may be accounted for at a later time) and merchant_transactions which contains data related to transactions for a given merchant. In various embodiments, the date range surveyed may be in a then-current quarter.

In various embodiments, merchants may code transaction points (i.e., points of sale) within a transaction system to represent a merchant category. For example, a fuel station may code a point of sale at a pump as “Transportation-Fuel,” a warehouse club may code a point of sale “Merchandise & Supplies—Wholesale Stores,” a grocery store may code a point of sale, “Merchandise & Supplies—Groceries,” a casual dining restaurant may code a point of sale, “Restaurant—Bar & Café,” and a may code a point of sale telecommunications company as “Communications—Mobile Telecomm,” although any methodology of coding and any coding category is contemplated herein. In various embodiments, raw consumer spend is determined by category. In this manner, categories of industries may be separately tracked. For example, the restaurant industry may experience a surge in sales, but a look at industry category may reveal a surge in the “bar and café” category but weak sales in the “fine dining” category. In various embodiments, the raw consumer spend may be filtered by both category and location (e.g., ZIP+4), so raw consumer spend in specific localities may be tracked by category. For example, a rise in raw consumer spend of “fine dining” in a particular ZIP+4 may be identified. A category may also include a distribution channel, for example, by bricks and mortar sales, online sales, bulk sales (e.g., business to business sales) or wholesales.

Various statistical methods, such as Monte Carlo methods, may be used to estimate or extrapolate the total spend at the merchant based upon the internal data and/or other factors. For example, it may be estimated how many customers of a merchant pay using cash or a rival transaction system. Thus, if a given transaction system is seeing a certain level of consumer spend, the given payment system may predict that another transaction system is seeing a similar level of consumer spend, and that certain amount of consumer spend occurs in cash. For example, if it is believed that a merchant has sales of roughly 25% transaction system A, 50% transaction system B, and 25% cash, internal data from transaction system A may determine its level of consumer spend with the merchant to arrive at a raw consumer spend value. The raw consumer spend is then multiplied by 4 to yield an estimated consumer spend for the merchant. Other factors may be taken into account during such calculation. A transaction system may take into account if its consumers typically spend more at a merchant than those of another transaction system or those who pay cash. Thus, internal data from the high value transaction system may reduce the estimated consumer spend of other transaction systems and cash to avoid overestimating.

In various embodiments, merchants may provide merchant data for analysis. Merchant data may comprise a transaction history (including stock keeping units “SKUs” purchased, also referred to as SKU level data) and/or customer data. Thus, the raw consumer spend and the estimated consumer spend may be calculated per SKU.

In this regard, a real time or nearly real time monitoring of spend at various merchants may be created. Thus, in a given yearly quarter, for example, consumer spend at a given merchant may be sampled, for example, one month into a given quarter. The raw consumer spend may be extrapolated to include other payment forms and may then be projected two months in the future. In this manner, an estimated consumer spend for the quarter may be determined two months ahead of the quarter end and any official earnings report. In various embodiments, follow up estimation may occur at, for example, two months into a given quarter to update and enhance the estimated consumer spend for the quarter.

The estimation of consumer spend from raw consumer spend may take into account any relevant or potentially relevant variable. For example, seasonal adjustments may be made. For example, for the fourth quarter, retail sales in October may not have a straight line relationship with sales for November and December, which are typically marked by holiday-season sales increased. Thus, the estimation of consumer spend from raw consumer spend using October data may seasonally adjust its estimation. Also for example, certain categories may be seasonally adjusted. Sales of hunting bows may be adjusted to account for peak pre-hunting season sales and office supplies may be seasonally adjusted for the August/September “back to school” season.

Estimating top line revenue may be performed by taking estimated consumer spend and adding an appropriate amount to account for other merchant sources of income. For example, it may be known that a merchant disposed of appreciated capital assets in a quarter, and thus the gain would be added to top line revenue. Moreover, a merchant may have been owed money on a judgment, so such income would be added to the estimated consumer spend. Any source of revenue is contemplated to be relevant for this purpose herein, and any suitable accounting method may be used (for example, those accounting methods compliant with GAAP). For example, the estimate may be made in conformance with the accrual based or cash based accounting method of the merchant.

Estimating bottom line revenue may be performed by taking estimated consumer spend and subtracting an appropriate amount to account for merchant expenses. Any cost that is likely incurred, may be incurred, or is known to have been incurred by a merchant may be used in this calculation In various embodiments, third party data sources may provide data relating to merchant costs, including past merchant financial reports. For example, if a merchant is expected to take a charge in a quarter for a given reason (e.g., payment on a judgment, capital loss, depreciation, etc), this amount may be subtracted from the estimated consumer spend. Moreover, if the cost of inputs has risen, the estimated consumer spend may be offset by that amount. Any source of cost is contemplated to be relevant for this purpose herein, and any suitable accounting method may be used (for example, those accounting methods compliant with GAAP).

Extrapolating raw consumer spend into estimated consumer spend and estimating top line and/or bottom line revenue may be performed by a normalization module. A normalization module may comprise a processor and a non-transitory, tangible memory.

In various embodiments, estimated consumer spend for a company, industry, category, or SKU may be used to predict future consumer spend and/or future industry consumer spend at a time in the future. For example, estimated consumer spend may be adjusted in response to various factors, such as trends in internal data (i.e., the purchasing decisions of consumers in the internal data), seasonal factors, macroeconomic factors (i.e., factors describing the economy as whole such as the unemployment rate or the consumer price index), or external party data. External party data may be any data that is obtained from a third party, whether public or private. For example, external party data may comprise credit bureau information (consumer tradelines, credit scores, etc), information relating to companies such as those found in SEC filings, and the like.

Predicting future consumer spend for a company may predict future consumer spend based upon historical consumer spend, but also future activities of the company. For example, a company that is rapidly expanding to new locations would have an increase in future consumer spend, provided those locations located in areas where internal data shows that there is demand for the company's items. Also for example, changing tastes may be accounted for. If consumer spend on coffee is declining and consumer spend on tea is increasing, the future consumer spend on coffee merchants may be downwardly adjusted.

Predicting future industry consumer spend may comprise predicting future consumer spend over a number of companies within an industry or category. This may be accomplished by predicting future consumer spend for each company and summing together.

In various embodiments, predicting future consumer spend may be useful for companies that do not engage in significant amounts of direct to consumer transactions. For example, a jet engine supplier sells to a small number of aircraft manufacturers. However, by looking at airline industry consumer spend, the needs of the airline industry become apparent. Jet engines have a fixed useful life, and increased usage hastens the need for replacement or rebuilding. Thus, future consumer spend in the aircraft jet engine industry may be determined by using estimated consumer spend in the airline industry. In like manner, increase energy consumption may be indicative of a need for new sales of energy creating devices (turbines, etc). In addition, lagging trends may also be used in the prediction process. For example, a decrease in home improvement store sales may indicate a subsequent downturn in the resale housing market.

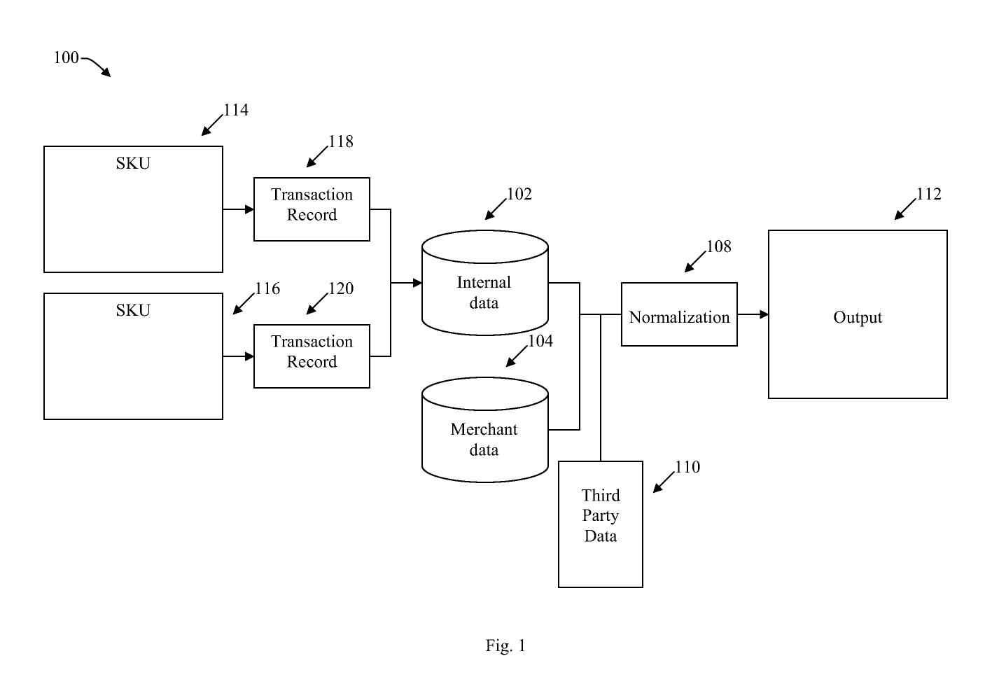

With reference to FIG. 1, system 100, in accordance with various embodiments, is illustrated. Data store 102 is illustrated having internal data derived from a transaction system. Data store 104 is illustrated having merchant data. Transactional records 118 and 120, in various embodiments, are shown entering data store 102 to become internal data. Transactional records 118 and 120 may comprise transactional data such as transaction time, transaction place, transaction amount, and the consumer and merchant participating in the transaction. In various embodiments, transactional records 118 and 120 comprise SKU level data 114 and 116. SKU level data 114 and 116 contain the specific SKUs related to transactional records 118 and 120. Third party data store 110 may be one or more third parties that supply data to normalization module 108. Third party data store 110 may be one or more of a credit bureau, a government database (e.g., county tax assessor database or state taxing authority database), information derived from a social network (e.g, Facebook or Twitter), information derived from a smartphone such as historical and present location, past merchant financial reports and the like.

As may be appreciated, the raw consumer spend and estimated consumer spend may be produced by merchant but also by industry or by industry “leaders.” In various embodiments, estimated consumer spend and/or top line revenue is determined for a set of merchants within an industry. These estimated consumer spend and/or top line revenue values are summed to create industry estimated consumer spend and/or industry top line revenue. While an entire industry may be analyzed, any subset of industry may be analyzed as well. For example, the industry leaders (e.g., top three big box stores) may be grouped together.

Normalization module 108 is illustrated as configured to receive internal data from data store 102, merchant data from data store 104, third party data store 110 and transactional records 118 and 120. Normalization module 108 is configured to perform the extrapolating of estimated consumer spend from raw consumer spend and the estimation of top line revenue as described herein. Normalization module 108, in various embodiments, may produce output 112.

Normalization module 108 may also output indexed results. For example, an output may comprise a measurement that relates the estimated consumer spend to another value. For example, the national average size of wallet of a consumer per industry (i.e., the amount a consumer spends in a given industry per month) may be set arbitrarily at 100 in year 1. Then, in January of year 2 (i.e., quarter 1), an estimated consumer spend for the industry may be calculated to be twice as high as the average for year 1, and thus be output as 200. In this manner, relative change against a known baseline may be conveyed without disclosing the underlying amount. Thus, indexing may be useful in that is provides concrete trend information yet preserves specific aggregate data.

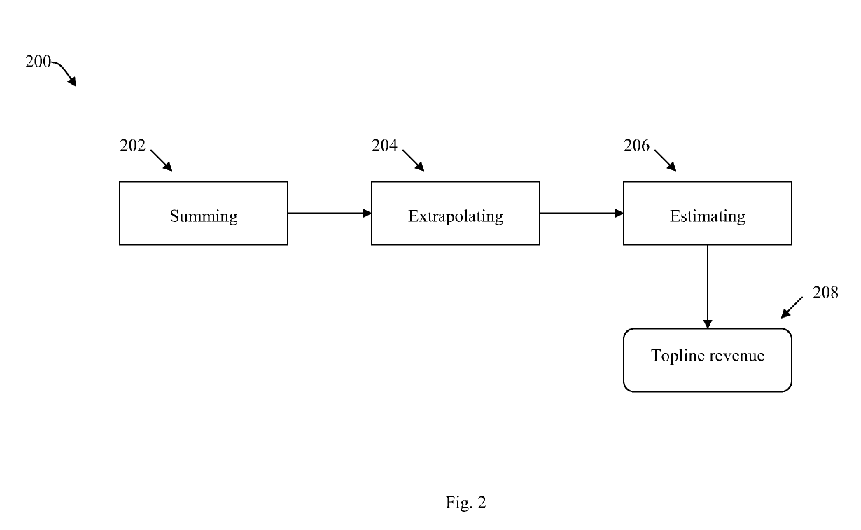

With reference to FIG. 2, method 200 is illustrated. Summing 202 may comprise the summation of consumer spend found in internal data for a given time period, such as by methods described above. For example, the total transaction amount for a given merchant for the given time period may be summed. Corrections may be made to exclude sales taxes. The raw consumer spend is thus produced by summing 202.

Extrapolating 204 may comprise deriving the estimated consumer spend from the raw consumer spend. Thus, as described above, the raw consumer spend may be adjusted to account for consumers who pay using disparate transaction systems and those who pay cash. Data regarding a merchant's payment type may be used in extrapolating 204, but in various embodiments statistical sampling methods are employed to determine the estimated consumer spend.

Estimating 206 may comprise estimating the top line revenue 208. As described above, any suitable method may be used to adjust estimated consumer spend to better represent top line revenue of a merchant.

Method 200 may be repeated for multiple merchants within an industry or category and the resulting industry estimated consumer spend and/or top line revenue may used as the industry estimated consumer spend or the industry top line revenue.

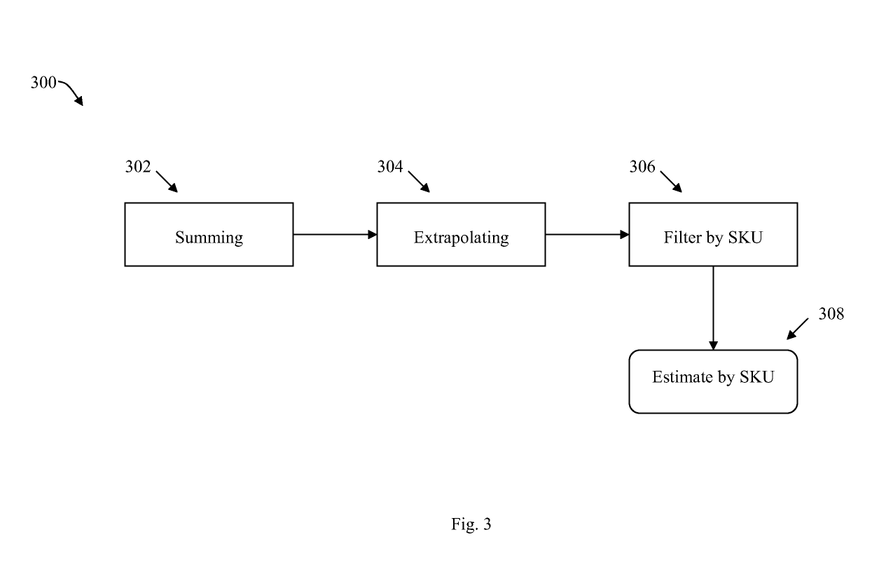

With reference to FIG. 3, method 300 is illustrated. Summing 302 may comprise the summation of consumer spend found in internal data for a given time period, such as by methods described above. For example, the total transaction amount for a given merchant for the given time period may be summed. Corrections may be made to exclude sales taxes. The raw consumer spend is thus produced by summing 302.

Extrapolating 304 may comprise deriving the estimated consumer spend from the raw consumer spend. Thus, as described above, the raw consumer spend may be adjusted to account for consumers who pay using disparate transaction systems and those who pay cash. Data regarding a merchant's payment type may be used in extrapolating 304, but in various embodiments statistical sampling methods are employed to determine the estimated consumer spend.

Filter by SKU 306 may comprise filtering the estimated consumer spend by SKU. For example, a discount retailer may sell tens of thousands of different items. Filtering by SKU data allows one to see the consumer spend on the particular SKU in the given time period. This information may be helpful to investors who invest in the maker of the SKU. Estimate by SKU 308 may comprise estimating the amount of top line revenue that is associated with sale of the particular SKU.

Method 300 may be repeated for multiple merchants within an industry or category and the resulting estimated consumer spend and/or top line revenue may used as the industry SKU estimated consumer spend or the industry SKU top line revenue.

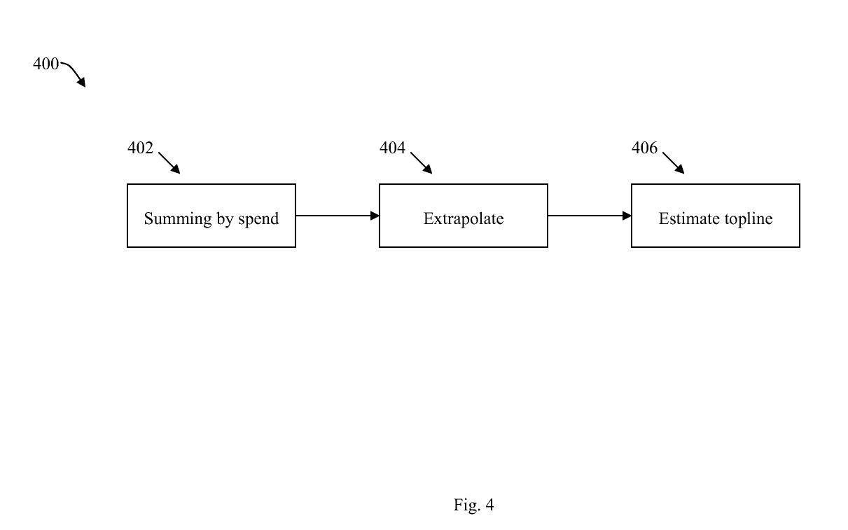

With reference to FIG. 4, method 400 is illustrated. Method 400 comprises producing an industry estimated consumer spend. Summing transaction spend 402 may comprise summing the consumer spend at a set of merchants to arrive at an industry raw consumer spend. Extrapolate 404 may comprise extrapolating the estimated consumer spend for the industry given the industry raw consumer spend. Estimate 406 may comprise estimating the industry top line revenue.

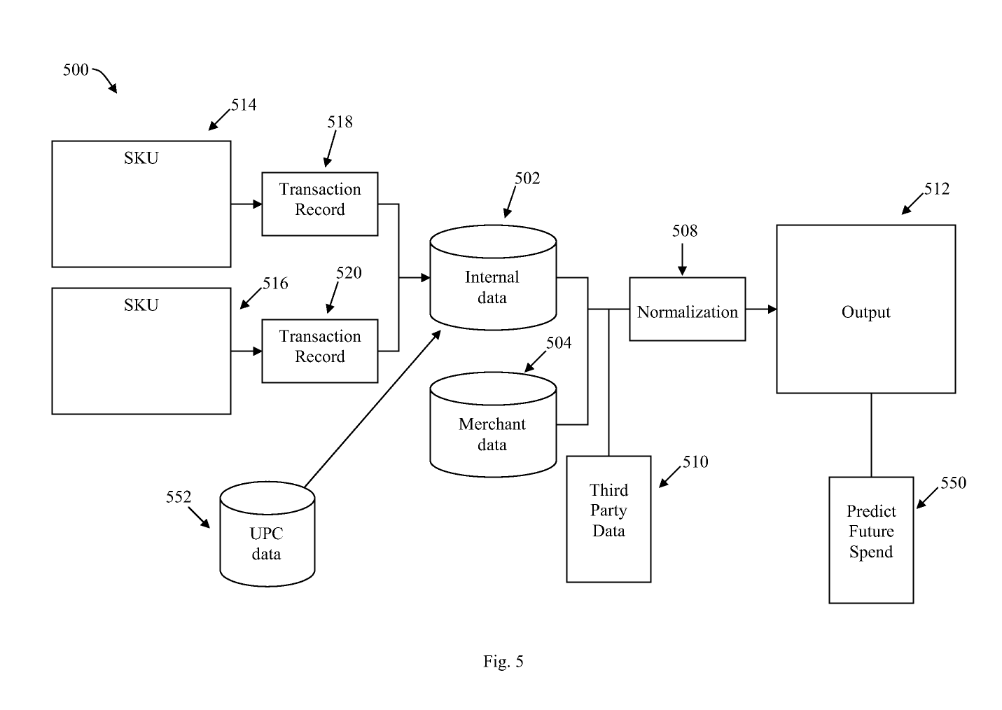

With reference to FIG. 5, system 500, in accordance with various embodiments, is illustrated. Data store 502 is illustrated having internal data derived from a transaction system. Data store 504 is illustrated having merchant data. Transactional records 518 and 520, in various embodiments, are shown entering data store 502 to become internal data. Transactional records 518 and 520 may comprise transactional data such as transaction time, transaction place, transaction amount, and the consumer and merchant participating in the transaction. In various embodiments, transactional records 518 and 520 comprise SKU level data 514 and 516. SKU level data 514 and 516 contain the specific SKUs related to transactional records 518 and 520. Third party data store 510 may be one or more third parties that supply data to normalization module 508. Third party data store 510 may be one or more of a credit bureau, a government database (e.g., county tax assessor database or state taxing authority database), information derived from a social network (e.g, Facebook or Twitter), information derived from a smartphone such as historical and present location, past merchant financial reports and the like.

UPC data 552 may also be configured to be merged or joined with internal data 102. UPC, or universal product code, represent data related to bar codes that are on many goods. UPC data 552 may also represent other data related to goods, such as the primary components or the most expensive components. For example, UPC data 552 may contain a code for a semiconductor. UPC data 552 may also note that the semiconductor contains a rare earth mineral. Thus, in later steps such as predict future spend 550, the presence of the rare earth mineral could be used in the prediction of future spend, for example, if rare earth commodity prices rise. UPC data 552 may also contain the country of origin or countries of origin for the parts for the item. Thus, if a natural of manmade disaster damages that country's ability to produce the product, it may be accounted for in, for example, predict future spend 550.

As may be appreciated, the raw consumer spend and estimated consumer spend may be produced by merchant but also by industry or by industry “leaders.” In various embodiments, estimated consumer spend and/or top line revenue is determined for a set of merchants within an industry. These estimated consumer spend and/or top line revenue values are summed to create industry estimated consumer spend and/or industry top line revenue. While an entire industry may be analyzed, any subset of industry may be analyzed as well. For example, the industry leaders (e.g., top three big box stores) may be grouped together.

Normalization module 108 is illustrated as configured to receive internal data from data store 502, merchant data from data store 504, third party data store 510 and transactional records 518 and 520. Normalization module 508 is configured to perform the extrapolating of estimated consumer spend from raw consumer spend and the estimation of top line revenue as described herein. Normalization module 508, in various embodiments, may produce output 512.

Normalization module 508 may also output indexed results. For example, an output may comprise a measurement that relates the estimated consumer spend to another value. For example, the national average size of wallet of a consumer per industry (i.e., the amount a consumer spends in a given industry per month) may be set arbitrarily at 100 in year 1. Then, in January of year 2 (i.e., quarter 1), an estimated consumer spend for the industry may be calculated to be twice as high as the average for year 1, and thus be output as 200. In this manner, relative change against a known baseline may be conveyed without disclosing the underlying amount. Thus, indexing may be useful in that is provides concrete trend information yet preserves specific aggregate data.

Output 512 may be used to predict future spend 550. Predict future spend 550 may use estimated consumer spend, internal data, external party data, SKU data, and/or UPC data to predict consumer spend in future time periods, as described herein.

The systems and methods disclosed herein may be useful in any financial or investment business. By accurately estimating consumer spend or top line revenue, investors may make decisions regarding a company's stock (e.g., buy, sell or hold). Investors that have derivatives having a company's stock as an underlying asset may also be interested in the estimated consumer spend to make disposition decisions regarding the derivatives. Real estate investors, for example, may use industry estimated consumer spend to identify fast growing merchants (perhaps by geographic location) and thus engage in real estate transactions in anticipation of future expansion.

An investor who identifies a fast growing item or item category may invest in the new item's production. Seasonal manufacturers may look at year over year trends to benchmark production for the next season's items. Economists may use estimated consumer spend to show shifts in the economy (e.g., increase in estimated consumer spend at discount retailers versus full service retailers or an increase in estimated consumer spend at “fast casual” restaurants versus “casual dining” restaurants).

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: internal data, client data; merchant data; financial institution data; and/or like data useful in the operation of the system. As those skilled in the art will appreciate, a computer may include an operating system (e.g., Windows NT, 95/98/2000, XP, Vista, OS2, UNIX, Linux, Solaris, MacOS, iOS, Android, etc.) as well as various conventional support software and drivers typically associated with computers. A user may include any individual, business, entity, government organization, software and/or hardware that interact with a system.

A web client includes any device (e.g., personal computer or smartphone or tablet computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as tablet computers (e.g., tablets running Android, iPads), iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, Opera, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile/XP/Vista/7, OS2, UNIX, Linux, Solaris, MacOS, MacOS X, PalmOS, iOS, Android, etc.) as well as various conventional support software and drivers typically associated with computers. A web client may include any suitable personal computer, network computer, workstation, personal digital assistant, cellular phone, smartphone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, various components, modules, and/or engines of a system may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device), personal digital assistant/smartphone (e.g., iPhone®, Palm Pilot®, Blackberry®, and/or a device running Android), cellular phone, kiosk, etc., online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases or terms similar to “item” may include any good, service, information, experience, data, content, access, rental, lease, contribution, account, credit, debit, benefit, right, monetary value, non-monetary value and/or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems. Any form of encryption may be used to implement a secure channel, as described herein.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security Principles & Practice” by William Stallings, published by Prentice Hall; all of which are hereby incorporated by reference.

In various embodiments, each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank may have a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks. A transaction system may comprise a payment network.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

The process flows and screenshots illustrated or described are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements, but also to the various system components as described herein.

The computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases similar to a “payment processor” may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to at least one of A, B, and C or at least one of A, B, or C is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising:
summing, by an industry spend processor, consumer spend with a first company over a time period to yield a raw consumer spend, wherein the consumer spend is derived from internal data;
multiplying, by the processor, the raw consumer spend by a multiplier that is based upon an estimate of the total sales of the first company;
extrapolating, by the processor and based upon the multiplying, an estimated consumer spend with the first company; and
estimating, by the processor, top line revenue for the first company using the estimated consumer spend.

2. The method of claim 1, further comprising estimating, by the processor, new revenue from the top line revenue using data from a public data source.

3. The method of claim 1, further comprising:
summing, by the processor, consumer spend with a plurality of companies within the industry of the first company over the time period and the raw consumer spend to yield a raw industry consumer spend;
extrapolating, by the processor, an industry estimated consumer spend using the raw industry consumer spend and the internal data; and
estimating, by the processor, top line revenue for the industry using the industry estimated consumer spend.

4. The method of claim 3, further comprising estimating top line revenue for a subportion of the industry.

5. The method of claim 3, further comprising using internal data to filter the industry estimated consumer spend by at least one of geographic location, gender, age, annual income level and education level.

6. The method of claim 5, further comprising making an industry growth prediction based upon the filtered industry estimated consumer spend.

7. The method of claim 3, further comprising determining whether to at least one of buy and sell stock of the first company based upon the estimated top line revenue for the industry.

8. The method of claim 1, further comprising making a growth prediction for the first company based upon the estimated top line revenue.

9. The method of claim 1, further comprising predicting the value change in a derivative having stock of the first company as an underlying security.

10. The method of claim 5, further comprising predicting the value change in a derivative having stock of at least one of the companies in the plurality of companies as an underlying security.

11. The method of claim 1, further comprising integrating SKU level data into the internal data.

12. The method of claim 11, further comprising summing consumer spend on an item with the first company over the time period to yield item consumer spend.

13. The method of claim 12, predicting the overall sales of the item based upon the item consumer spend.

14. A system comprising:
a processor for analyzing industry spend,
a tangible, non-transitory memory configured to communicate with the processor,
the tangible, non-transitory memory having instructions stored thereon that, in response to execution by the processor, cause the processor to be capable of performing operations comprising:
summing, by the processor, consumer spend with a first company over a time period to yield a raw consumer spend, wherein the consumer spend is derived from internal data;
multiplying, by the processor, the raw consumer spend by a multiplier that is based upon an estimate of the total sales of the first company;
extrapolating, by the processor and based upon the multiplying, an estimated consumer spend with the first company; and
estimating, by the processor, top line revenue for the first company using the estimated consumer spend.

15. The system of claim 14, further comprising estimating, by the processor, the estimated consumer spend based upon credit bureau data.

16. The system of claim 15, further comprising predicting, by the processor, future industry consumer spend based upon SKU level data.

17. The system of claim 16, wherein the operations further comprise predicting the value change in a derivative having stock of the first company as an underlying security.

18. The system of claim 16, wherein the operations further comprise making a growth prediction for the first company based upon the estimated top line revenue.

19. The system of claim 16, further comprising:
summing, by the processor, consumer spend with the plurality of companies within the industry over the time period and the raw consumer spend to yield a raw industry consumer spend;
extrapolating, by the processor, an industry estimated consumer spend using the raw industry consumer spend and the internal data; and
estimating, by the processor, top line revenue for the industry using the industry estimated consumer spend.

20. An article of manufacture including a non-transitory tangible computer readable storage medium having instructions stored thereon that, in response to execution by a computer-based system for analyzing industry spend, cause the computer-based system to be capable of performing operations comprising:
summing, by the computer-based system, consumer spend with a first company over a time period to yield a raw consumer spend, wherein the consumer spend is derived from internal data;
multiplying, by the computer-based system, the raw consumer spend by a multiplier that is based upon an estimate of the total sales of the first company:
extrapolating, by the computer-based system and based upon the multiplying, an estimated consumer spend with the first company; and
estimating, by the computer-based system, top line revenue for the first company using the estimated consumer spend.
